(19) United States
(12) Patent Application Publication
(10) Pub. No.: US 2014/0125176 A1
(43) Pub. Date: May 8, 2014

(54) Hybrid Bearing

(71) Applicant: Waukesha Bearings Corporation, Pewaukee, WI (US)

(72) Inventor: Michael K. Swann, Gales Ferry, CT (US)

(73) Assignee: Waukesha Bearings Corporation, Pewaukee, WI (US)

(21) Appl. No.: 14/075,791

(22) Filed: Nov. 8, 2013

Related U.S. Application Data
(60) Provisional application No. 61/724,179, filed on Nov. 8, 2012.

(51) Int. Cl. F16C 32/04; F16C 32/06

(52) U.S. Cl. CPC F16C 32/0474; F16C 32/0614
USPC 310/90.5

(57) ABSTRACT

A method and apparatus for radial and axial hybrid bearings using gas sector(s) and magnetic sector(s) to increase bearing load capacity and stiffness, reduce bearing size and bearing span, and reduce cost comprises a stator and a rotor. An illustrative embodiment of a stator for use with a hybrid bearing may include one or more bearing pads positioned in a gas sector, and the stator may also include one or more magnetic sectors. The hybrid bearings may provide for the elimination of much of the magnetic bearing structure and associated power electronics using a pressurized gas/air bearing to react the bearing steady load while reserving the magnetic bearing and its controls to react dynamic loads and stabilize the bearing. In addition, the magnetic bearing controls for a hybrid bearing may be used to monitor bearing operating condition and provide communications of these conditions to the outside world.

### CROSS REFERENCE TO RELATED APPLICATIONS

This application claims priority from provisional U.S. Pat. App. No. 61/724,179 filed on Nov. 8, 2012, which is incorporated by reference herein in its entirety.

### FIELD OF INVENTION

### Statement Regarding Federally Sponsored Research or Development

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND

Active magnetic bearing technology provides for the support of a machine rotor by means of the force of electromagnetic attraction between stator and rotor components constructed of ferromagnetic materials through which magnetic circuits are created by electrical coils. One example of an active magnetic bearing is disclosed in U.S. Pat. No. 5,111,102, which is incorporated by reference herein in its entirety. This force of attraction is quite different from the principle of all mechanical bearings that react loads by pushing against them. While mechanical bearings act to repulse loads, magnetic bearings may operate by attracting loads by acting from the opposite side of the rotor.

A ferromagnetic structure is typically required for both the stator and rotor components; typically this is in the form of standard electrical steel lamination packs. These may be oriented in the transverse plane of the rotor for radial bearings. For axial bearings the lamination packs may be oriented in the longitudinal direction of the rotor. The magnetic circuits are developed by the flow of electrical current in coils mounted around the magnetic cores.

Present state of the art for magnetic bearing technology requires enveloping the rotor completely by magnetic circuits of alternating polarity. This not only allows the largest load capacity to be developed, but it also provides for linearization of the relationship between the bearing force developed and the rotor displacement in the gap between rotor and stator. Linearization may allow for the use of less sophisticated controls for practical implementation.

In the case of a radial magnetic bearing 16a, the conventional arrangement commonly dictates that the machine rotor is usually enveloped by the radial magnetic bearing 16a over a full 360°. This type of configuration is shown generally in the foreground of FIG. 1. FIG. 2 shows an industrial version of a stator that may be used with this type of design. The mating rotor component is shown in industrial form in FIG. 3. In the case of an axial or thrust magnetic bearing 16b, this arrangement may require that the rotor component, the thrust collar, is enveloped by 360° planar stator components on both sides of the collar, as shown in the background of FIG. 1. FIG. 4 shows an industrial version of a stator that may be used with this type of design. The rotor for the axial magnetic bearing 16b is typically a finely machined solid steel, plain disk or collar. Note that both bearing types, radial magnetic bearings 16a and axial magnetic bearings 16b, must be actively cooled in most applications by passing a cooling gas between the rotor and stator surfaces to remove the heat generated from bearing operation.

Disadvantages of these pure electromagnetic designs include the large space that these bearings occupy inside the machine, and the associated cost of building these large bearings 16a, 16b and their associated power electronics. The large space requirement is more than just a penalty in machine size. Large bearings 16a, 16b increase the span between the machine bearings supporting a rotor, which increase is almost always a detrimental effect on the rotor dynamics because the resultant rotor natural frequencies (critical speeds) are often located in the operating speed range causing excessive machine vibration. In the worst scenarios this can mean a complete inability to operate the machine.

Another disadvantage of pure magnetic bearing 16a, 16b designs is the relatively low stiffness of the magnetic suspension created by the bearings 16a, 16b at high frequencies of excitation. This often limits the ability of the magnetic bearing 16a, 16b system to control the placement of critical speeds to push them out of the operating speed range of the machine rotor.

Finally, these conventional designs typically lack any type of redundancy or overload protection and a separate auxiliary bearing must also be employed to protect the rotor and machine internals in the event of magnetic bearing 16a, 16b failure or overload. This auxiliary bearing is typically some type of mechanical bearing, which requires additional space and cost.

Tilting pad journal bearings are another type of bearing commonly found in the prior art that may be configured as a magnetic bearing 16a, 16b. Generally, tilting pad journal bearings may employ an array of bearing pads mounted adjacent some type of rotor. The bearing pads may be biased toward the rotor. One specific type of tilting pad journal bearing is disclosed in U.S. Pat. No. 7,611,286, which is incorporated by reference herein in its entirety.

Air bearings are another type of bearing commonly found in the prior art. Generally, air bearings may utilize a thin film of pressurized air to provide a load-bearing interface between surfaces. As such, air bearings are typically non-contacting bearings. One specific type of non-contacting porous air bearing is disclosed in U.S. Pat. No. 7,908,885 as well as U.S. application Ser. No. 13/733,806, and another air bearing is disclosed in U.S. Pat. No. 8,517,665, all of which are incorporated by reference herein in their entireties.

A perspective view of a first illustrative embodiment of a radial magnetic bearing 16a (foreground) and a first illustrative embodiment of an axial magnetic bearing 16b (background) is shown in FIG. 1. As previously described, magnetic bearings 16a, 16b of these types are typically found in the prior art. A stator for an industrial-type of the illustrative embodiment of a radial magnetic bearing 16a is shown in FIG. 2, and a rotor that may be used therewith is shown in FIG. 3. A perspective view of an industrial version of a stator that may be used with the first illustrative embodiment of an axial magnetic bearing 16b is shown in FIG. 4.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limited of its scope, the invention will be described and explained with additional specificity and detail through the use of the accompanying drawings.

FIG. 1 is a perspective view a first illustrative embodiment of a radial magnetic bearing in the foreground and a first illustrative embodiment of an axial magnetic bearing in the background.

FIG. 2 is a perspective view of an industrial version of the stator for the first illustrative embodiment of a radial magnetic bearing.

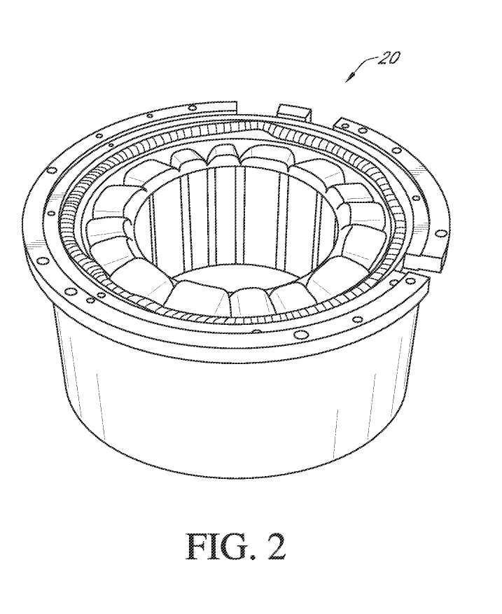

FIG. 3 is a perspective view of the rotor that may be used with the stator shown in FIG. 2.

FIG. 4 is a perspective view of an industrial version of the stator for the first illustrative embodiment of an axial magnetic bearing.

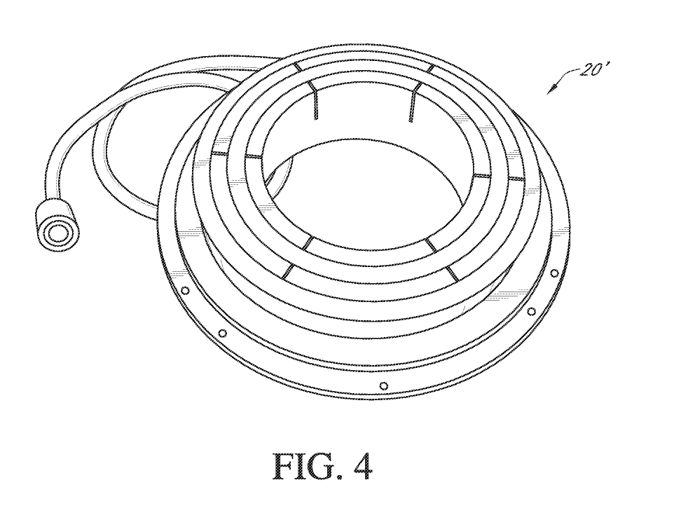

FIG. 5 is a perspective view a first illustrative embodiment of a radial hybrid bearing in the foreground and a first illustrative embodiment of an axial hybrid bearing in the background.

FIG. 6A is an axial cross-section view of the first illustrative embodiment of a radial hybrid bearing.

FIG. 6B is a detailed side view of one illustrative embodiment of a bearing pad that may be used with various embodiments of a radial hybrid bearing.

FIG. 6C is an axial cross-section view of the first illustrative embodiment of a radial hybrid bearing with the shaft and rotor removed for clarity.

FIG. 7A is a perspective view of one illustrative embodiment of an axial bearing stator that may be used with various embodiments of an axial hybrid bearing 10′.

FIG. 7B is an axial view of the embodiment of an axial bearing stator shown in FIG. 7A.

| ELEMENT DESCRIPTION | ELEMENT # |
|---|---|
| Radial hybrid bearing | 10 |
| Axial hybrid bearing | 10′ |
| Shaft | 12 |
| Bearing housing | 14 |
| Radial magnetic bearing | 16a |
| Axial magnetic bearing | 16b |
| Radial bearing stator | 20 |
| Gas sector | 22 |
| Bearing pad | 23 |
| Active surface | 23a |
| Sealed surface | 23b |
| Support | 23c |
| Port | 23d |
| Magnetic sector | 24 |
| Post | 25 |
| Coil | 26 |
| Retaining member | 28 |
| Axial bearing stator | 20′ |
| Gas sector | 22′ |
| Bearing pad | 23′ |
| Active surface | 23a′ |
| Sealed surface | 23b′ |
| Channel | 23c′ |
| Magnetic sector | 24′ |
| Coil | 26′ |
| Radial bearing rotor | 30 |
| Axial bearing rotor (thrust collar) | 30' |

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

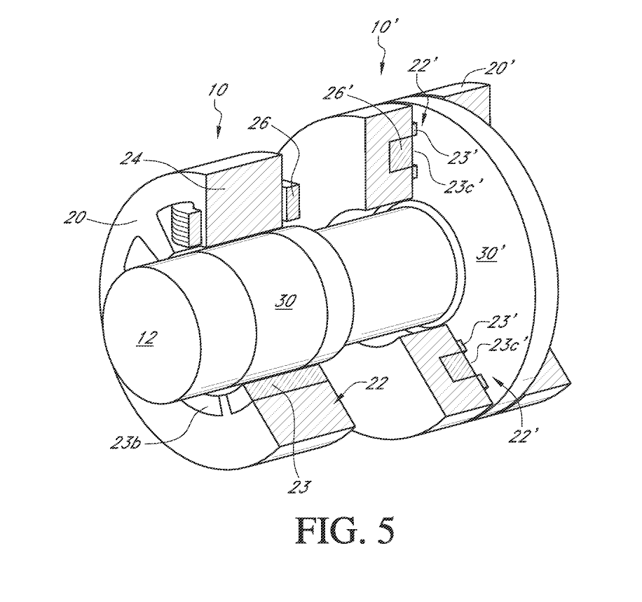

Referring now to the drawings, wherein like reference numerals designate identical or corresponding parts throughout the several view, FIG. 5 provides a perspective view of a first illustrative embodiment of a radial hybrid bearing 10 in the foreground and a perspective view of a first illustrative embodiment of an axial hybrid bearing 10′ in the background. In order to (among other advantages) increase bearing load capacity and stiffness, reduce bearing size and bearing span, and reduce cost, the radial hybrid bearing 10 and axial hybrid bearing 10′ disclosed herein may be employed. The hybrid bearings 10, 10′ may allow for elimination of much of the magnetic bearing structure and associated power electronics using a pressurized gas bearing to react the bearing steady load while reserving the magnetic bearing and its controls to react dynamic loads and stabilize the bearing. In addition, as provided by conventional magnetic bearing technology, the magnetic bearing controls may be used in hybrid bearings 10, 10′ to monitor hybrid bearing 10, 10′ operating condition and provide communications of these conditions to a remote location.

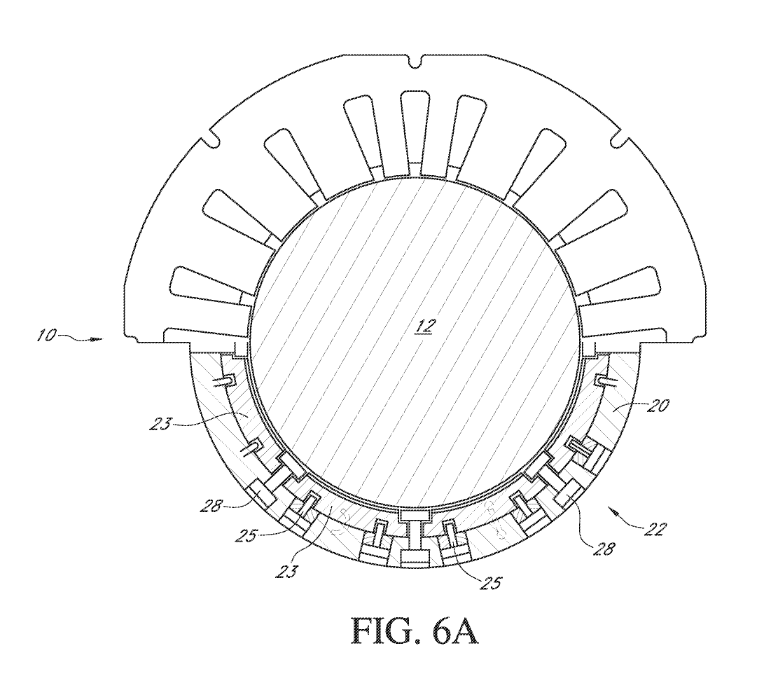

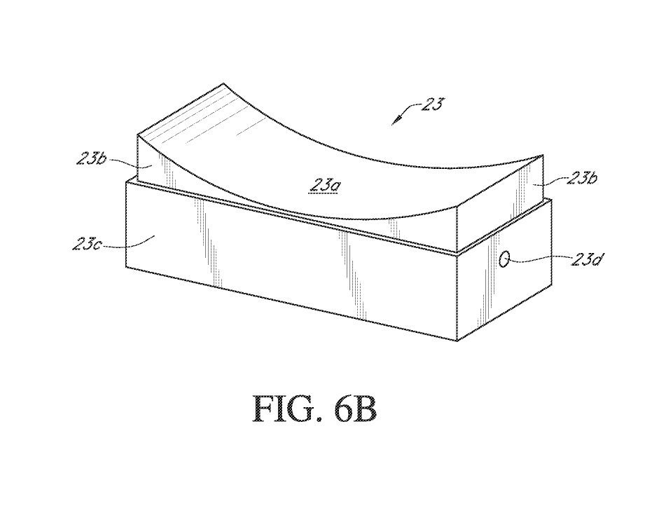

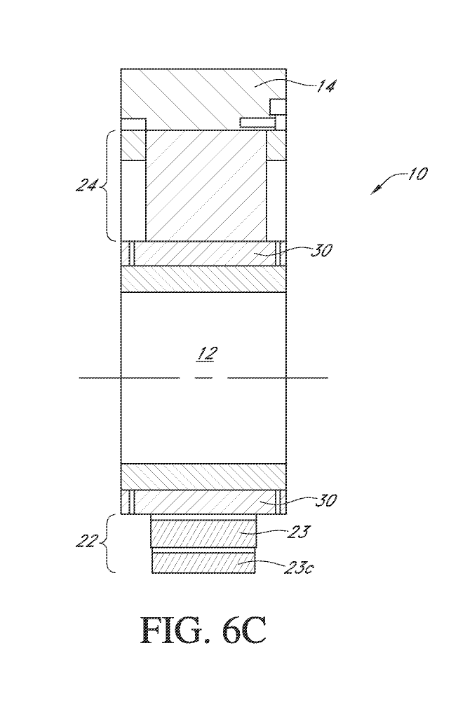

In the illustrative embodiment of the radial hybrid bearing 10 and the axial hybrid bearing 10′, the gas bearing portion(s) and the magnetic bearing portion(s) may be configured to occupy the same axial space, and thereby provide dual functionality augmenting each other. This scheme may be employed to facilitate a measure of bearing redundancy; if one bearing type fails (gas or magnetic), the remaining bearing may still provide for continuous operation, albeit at a likely higher vibration level. Such redundancy may require a change in the magnetic bearing control algorithm in the event of a gas bearing failure. In the event of a magnetic bearing failure the gas bearing clearance may be automatically adjusted to compensate for the lack of magnetic bearing support as the rotor seeks a new equilibrium position with respect to the bearing pads supported on their individual spring supports, thereby effectively changing the bore of the bearing 10, 10′. Thus, the hybrid bearings 10, 10′ may provide an intrinsic auxiliary bearing functionality. Protection against large overloads may be enabled with a simple bump stop constructed of self-lubricating materials, many of which bump stops are known to those of ordinary skill in the art and will not be described further herein.

Whereas there are several types of gas bearings operating on both hydrostatic and hydrodynamic operating principles, the type that may most readily integrate with magnetic bearing technology is the porous air bearing, a type of hydrostatic gas bearing. These bearings may be comprised of several discrete bearing pads 23, 23′. FIG. 6B shows an industrial version of one illustrative bearing pad 23 that may be used with various embodiments of the radial hybrid bearing 10. These bearing pads 23 occupy only a sector or portion of the rotor circumference, and each bearing pad 23 may operate independently from one another. The illustrative embodiment of a bearing pad 23 shown in FIG. 6B may include an active surface 23a that is positioned adjacent the radial bearing rotor 30 during use. The opposite surface of the bearing pad 23 may be engaged with a support 23c to provide the desired structure and/or rigidity to the bearing pad 23 as well as provide an interface between the bearing pad 23 and a post 25 and/or bearing housing 14. Like other mechanical bearings, gas bearings react to a load by pushing against it. In this case, a gas film between the rotor 30, 30′ and stator 20, 20′ resists any rotor 30, 30′ motion toward the active surface 23a, 23a′; this resistance is generally referred to as the bearing stiffness, and the magnitude thereof varies with the frequency of rotor 30, 30′ motion.

As shown in FIG. 6B and as described in detail below and in additional detail in U.S. Pat. No. 7,611,286, one method and/or structure for supporting a bearing pad 23, 23′ is to engage a spring-loaded post 25 with a sealed surface 23b of the bearing pad 23. Additionally, retaining members 28 may be used to limit the movement of the bearing pads 23 in one or more dimensions, which is also described in detail in U.S. Pat. No. 7,611,286. Any suitable method and/or structure for supporting a bearing pad 23, 23′ may be used with the hybrid bearings 10, 10′ disclosed herein without limitation, including but not limited to ball-and-socket mounting structures or rigid mounting of a bearing pad 23, 23′ to a bearing stator 20, 20′ or other structure.

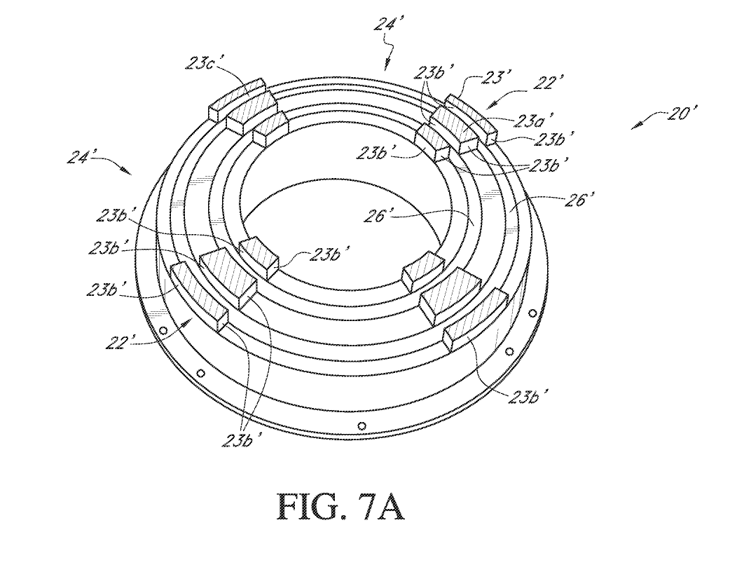

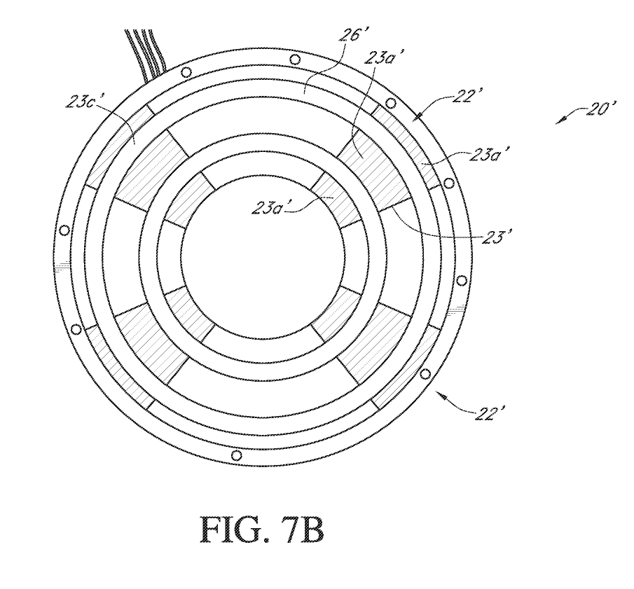

An illustrative bearing pad 23′ that may be used with certain embodiments of an axial hybrid bearing 10′ is shown in FIG. 7A, which provides a perspective view of an illustrative embodiment of an axial bearing stator 20′ according to the present disclosure. As those skilled in the art will appreciate, a typical arrangement for an axial hybrid bearing 10′ will comprise an axial bearing rotor 30′ (also sometimes referred to as a “thrust collar”) sandwiched between two axial bearing stators 20′.

The bearing pads 23, 23′ for use with porous air bearings are typically constructed of a porous carbon or similar media, wherein all but the active bearing surface (active surface 23a, 23a′) is typically sealed to retain internal gas pressure. Surfaces other than the active surface 23a, 23′ are referred to herein as sealed surfaces 23b, 23b′. Special compounds are used in the porous air bearing industry to provide this sealing capability. Clean pressurized air or gas may be introduced through a port 23d in a sealed surface 23b, 23b′ and naturally flows to the active surface 23a, 23a′ where it encounters the rotor 30, 30′ and reacts the load of the bearing. Any suitable compressed fluid source may be used to supply pressurized gas/air to the bearing pads 23, 23′, and the scope of the hybrid bearing 10, 10′ is in no way limited by the structure and/or method used for the compressed fluid source.

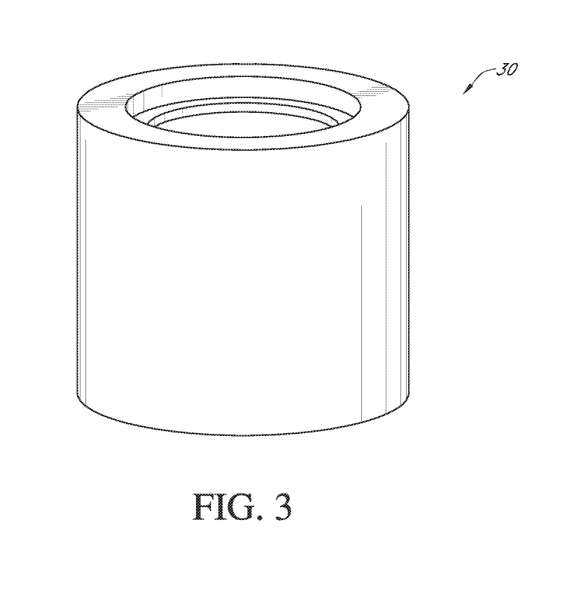

The pressurized air or gas may be supplied to each bearing pad 23, 23′ via any suitable conduit, and may enter the porous media at any suitable location. For example, in one embodiment the pressurized air or gas enters the bearing pad 23, 23′ on the side thereof. In another embodiment the pressurized air or gas enters the bearing pad 23, 23′ through a conduit formed in the post 25. Accordingly, the hybrid bearings 10, 10′ disclosed herein are in no way limited by the location and/or structure employed to deliver pressurized gas or air to a bearing pad 23, 23′. The mating rotor 30, 30′ component is typically a finely machined solid steel surface that is engaged with the shaft 12. However, the typical rotor 30, 30′ of a conventional radial magnetic bearing (which is often configured as a sleeve) with tightly packed laminations also may suffice, such as the radial bearing rotor 30 shown in FIG. 3.

In order to coordinate stable rotor 30, 30′ position control with the magnetic bearing controller, and simultaneously limit the gas/air consumption to that only required for rotor 30, 30′ support and hybrid bearing 10, 10′ cooling, the clearance of the active surface 23a, 23a′ in a gas sector 22, 22′ with respect to the rotor 30, 30′ surface may be controlled to just a few microns statically. When gas pressure is applied to the hybrid bearing 10, 10′, the high gas-film stiffness may overcome the stiffness of the structure that supports the bearing pad 23, 23′, which may cause the bearing pads 23, 23′ to back away from the rotor 30, 30′ surface to develop a full film at a stable equilibrium position with respect to the rotor 30, 30′. The running clearance of the gas sectors 22, 22′ may be substantially less than the clearance of the magnetic sectors 24, 24′. Accordingly, the bearing pads 23, 23′ may be proud relative to the magnetic sectors 24, 24′. This configuration is best shown for the embodiment of an axial bearing stator 20′ shown in FIG. 7A, which shows the axial dimension of the gas sector 22′ being greater than that of the magnetic sector 24′.

The coil 26′, which provides the magnetic field via an electric current, may be configured such that it forms one or more complete circles within the axial bearing stator 20′, as best shown in FIG. 7B. In this embodiment, the coil 26′ may be present even in gas sectors 22′ and may reside within a channel 23c′ formed in the bearing pad 23′. This configuration allows the coil 26′ to be adjacent the air gap along the entire length of the coil 26′. However, other configurations may be used without limitation, including but not limited to positioning a portion of the coil 26′ under the bearing pad 23′ in gas sectors 22′. The coil(s) 26 for a radial bearing stator 20 may be configured such that each coil 26 extends along the axial dimension of the radial bearing stator 20 by a predetermined amount. However, the scope of the hybrid bearings 10, 10′ disclosed herein is in no way limited by the configuration and/or type of coil 26, 26′ used therein. The variable electric current may be supplied to the coil(s) 26, 26′ via the magnetic bearing controller (not shown) in order to react the dynamic axial load.

The volumetric flow rate requirement for the gas sector(s) 22, 22′ may be very low because of the tight clearance between the bearing pads 23, 23′ and the rotor 30, 30′ even after pressurization. Additionally, the difference in clearances between the rotor 30 and the magnetic sector(s) 24, and between the rotor 30 and gas sector(s) 22 may often require that the radius of curvature of the bearing pad(s) 23 be different than that of the magnetic sectors 24 for a radial hybrid bearing 10.

The number and size of bearing pads 23, 23′ may be dictated by the rotor 30, 30′ size and the load on the bearing 10, 10′. Usually about 50% of the supply pressure of the air/gas to the bearing pad 23, 23′ can be recovered as useful bearing surface loading to counteract loads. In the herein disclosed hybrid bearings 10, 10′, the supply air or gas may not only used to supply the bearing “muscle”, but also may supply a ready means of cooling the hybrid bearings 10, 10′ (and specifically the magnetic sectors 24, 24′ thereof) by dissipating heat generated in the bearing gap between the rotor 30, 30′ and stator 20, 20′. In such a configuration, the temperature of the gas increases as it passes the hybrid bearing 10, 10′ surfaces and is exhausted outside the bearing compartment.

The gas bearing film stiffness may be much higher than the stiffness of the magnetic sectors 24, 24′ at all frequencies above zero (static conditions), but even this high film stiffness may be incapable of preventing momentary contact between the rotor 30, 30′ and the active surface 23a, 23a′ of the gas bearing pad 23, 23′ during upset conditions. Generally, it may be desirable to prevent and/or mitigate hard rotor 30, 30′ contact (impact) with the active surface 23a, 23a′ due to the low compressive strength of the porous material in many bearing pads 23, 23′. In addition, the high coefficient of friction of the porous material in the bearing pads 23, 23′ may give rise to adverse rotor 30, 30′ behavior (e.g. shaft whirl) upon contact.

To ameliorate hard contact conditions between the rotor 30, 30′ and the bearing pads 23, 23′, spring mounting of the bearing pads 23, 23′ may be used on the back side of the bearing pads 23, 23′, usually with one or more posts that engage a ball-and-socket connection. Importantly, this spring mounting also may be used to ensure the coordination of rotor 30, 30′ position control with the magnetic bearing controller as well as allowing/providing the proper amount of hybrid bearing 10, 10′ cooling flow as discussed above. Therefore, the spring mounting requires a proper selection of the gas bearing support spring deflection vs. force characteristic to allow the development of a stable gas film that properly works in conjunction with the magnetic sectors 24, 24′; Belleville springs are good candidates for this. However, often a trial-and-error method may be required to properly balance the support spring deflection vs. force characteristic for a given hybrid bearing 10, 10′ and/or application thereof. A hard bump stop may be included to limit maximum rotor 30, 30′ motion while preventing contact of the other rotor 30, 30′ and stator 20, 20′ components. This bump stop can be a short axial length bushing of self-lubricating material for radial hybrid bearing 10 designs. For axial hybrid bearing 10′ designs, sectors of an axial bearing rotor 30′ thrust washer constructed of self-lubricating materials may be needed. However, any other structure and/or method to mitigate hard contact between the rotor 30, 30′ and bearing pads 23, 23′ may be used without limitation.

The first illustrative embodiment of a radial hybrid bearing 10 design for a machine with a horizontal rotor may be to place active magnetic bearing coils 26 in the upper quadrants (magnetic sector 24) of the radial bearing stator 20 and use gas bearing pads 23 in the lower 180° segment (gas sector 22) of the radial hybrid bearing 10 to lift the radial bearing rotor 30, a configuration which is shown in the illustrative embodiment from an axial perspective in FIG. 6A. In some cases it may be advantageous to locate a separate bearing pad 23 at the 12 o'clock position of the radial bearing stator 20 in the magnetic sector 24 to allow a single force (gas/air pressure in this case) to act on the rotor 30, 30′ in two opposite directions. A simplified, axial cross-sectional view of the illustrative embodiment of a radial hybrid bearing 10 is shown in FIG. 6C, wherein the magnetic sector 24 is generally toward the top of the figure and the gas sector is generally toward the bottom of the figure. The entire radial bearing stator 20 (i.e., both the gas sector 22 and magnetic sector 24) may be engaged with a bearing housing 14 to support and/or retain the radial hybrid bearing 10.

Both the gas sectors 22 and magnetic sectors 24 of the radial bearing stator may feature an interface with a conventional radial magnetic bearing rotor 30, which radial bearing rotor 30 may be comprised of tightly packed electrical steel laminations as best shown in FIG. 3. This design allows the gas sectors 22 to counteract the static load due to weight, while the magnetic sectors 24 may be sized to counteract only dynamic loads due to radial bearing rotor 30 imbalance and aerodynamic loading. The optimal configuration for the radial bearing rotor 30 and axial bearing rotor 30′ for the hybrid bearings 10, 10′ will vary from one application of the hybrid bearing 10, 10′ to the next. However, it is contemplated that many applications will benefit from a rotor 30, 30′ constructed at least partially of a ferromagnetic material for proper interaction between the rotor 30, 30′ and the magnetic sectors 24, 24′. Because gas bearings have intrinsically poor damping, the magnetic sectors 24 may be used to stabilize high-speed operation by using its unique attribute of providing phase lead of the reacting bearing force relative to the imparted radial bearing rotor 30 force; this is the derivative control, “D” characteristic, of a Proportional Integral Derivative (PID) servo controller and the method by which damping is derived from a magnetic bearing, which is not described in detail herein for purposes of brevity.

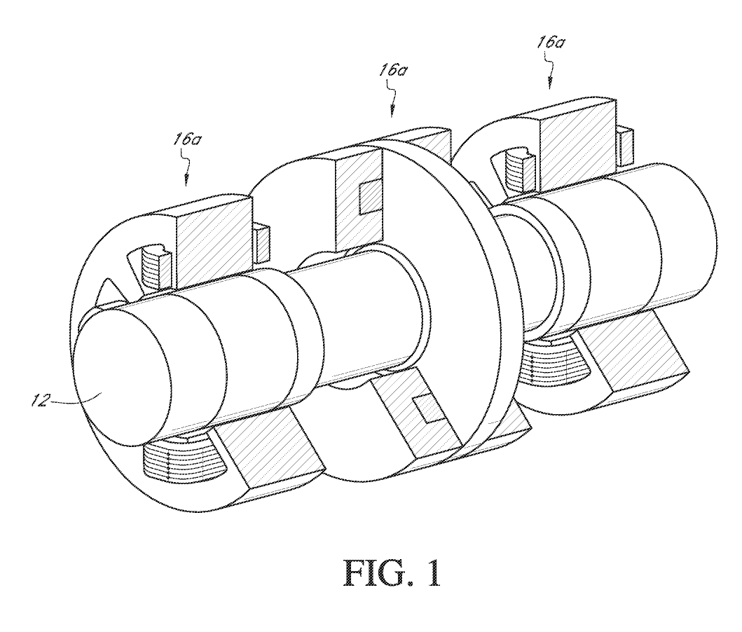

An illustrative embodiment of an axial hybrid bearing 10′ (which may be configured as a thrust bearing) having a horizontal axial bearing rotor 30′ orientation is shown in FIG. 5. This embodiment may use a small conventional magnetic thrust bearing (configured as one or more magnetic sectors 24′ on the axial bearing stator(s) 20′) augmented with gas sectors 22′ that may be used to counteract the steady aerodynamic thrust. The depiction in FIG. 5 does not portray the space savings generally possible in comparison to a prior art magnetic bearing as shown in FIG. 1. The actual space savings is dependent at least upon the magnitude of the gas pressure supply available.

In a machine with a vertically oriented rotor, the radial side loads are markedly less than in a horizontal configuration, but the axial hybrid bearing 10′ may be configured to react the entire static load. Accordingly, the shaft weight may be reacted by a multitude of properly sized gas bearing pads 23′ underneath a thrust collar (axial bearing rotor 30′). The upper side of the axial hybrid bearing 10′ in such a configuration may be occupied by a magnetic bearing and/or one or more magnetic sectors 24′ sized to assist the lower gas bearing and/or gas sectors 22′, particularly by reacting dynamic loads via its capability to develop a force of attraction at high frequency. Magnetic bearing coils 26′ may or may not be used on the lower axial bearing stator 20′ according to the application requirements. Where both an axial hybrid bearing 10′ and radial hybrid bearing 10 occupy the same space, the axial bearing stator 20′ may be sectioned into gas sectors 22′ and magnetic sectors 24′ to accommodate gas bearing pads 23′ that run from the basic hybrid bearing 10′ ID to the hybrid bearing 10′ OD, while the coils 26′ for the magnetic sectors 24′ may be retained in their full annular 360° form as best shown in FIGS. 7A & 7B. The radial bearing stator 30 may comprise appropriately sized versions of magnetic sectors 24 using coils 26 such as those shown in the radial magnetic bearing embodiment shown in FIG. 3 because little to no shaft weight must be reacted by the magnetic sector(s) 24 in the illustrative embodiment of the radial hybrid bearing 10.

A radial hybrid bearing 10 may also provide advantages over the prior art in machines with vertically oriented rotors. One such advantage is a decrease in size and cost of the bearing assembly. Such size reductions may allow a shorter span between bearings with an attendant reduction in machinery vibration issues.

In embodiments of radial hybrid bearings 10 that lack a double-sided magnetic sector(s) 24 that is identical on either side of the rotor 30, linearization of the magnetic attractive force vs. rotor 30 displacement characteristic may be recovered by special software algorithms that are in common usage already for so-called Class B control. A square root function of the bearing current command is typically employed.

The optimal dimensions and/or configuration of the gas sector(s) 22, 22′; bearing pad(s) 23, 23′; magnetic sector(s) 24, 24′; coil(s) 26, 26′ and rotor 30, 30′ will vary from one embodiment of the radial hybrid bearing 10 and axial hybrid bearing 10′ to the next, and are therefore in no way limiting to the scope thereof. The various elements of the hybrid bearing 10, 10′ may be formed of any material that is suitable for the application for which the hybrid bearing 10, 10′ is used. Such materials include but are not limited to metals and their metal alloys, polymeric materials, and/or combinations thereof.

Although the specific embodiments pictured and described herein pertain to a radial hybrid bearing 10 having one gas sector 22 and one magnetic sector 24 and an axial hybrid bearing 10′ having four gas sectors 22′ and four magnetic sectors 24′, the hybrid bearing 10 may be configured with other orientations and/or with different quantities of the various elements having different shapes and/or orientations. Accordingly, the scope of the hybrid bearing 10, 10′ is in no way limited by the specific shape and/or dimensions of the gas sector(s) 22, 22′; bearing pad(s) 23, 23′; magnetic sector(s) 24, 24′; coil(s) 26, 26′ and rotor 30, 30′ or the relative quantities, dimensions, orientations, and/or positions thereof.

Having described the preferred embodiments, other features, advantages, and/or efficiencies of the hybrid bearing 10, 10′ will undoubtedly occur to those versed in the art, as will numerous modifications and alterations of the disclosed embodiments and methods, all of which may be achieved without departing from the spirit and scope of the hybrid bearing 10, 10′ as disclosed and claimed herein. It should be noted that the hybrid bearing 10, 10′ is not limited to the specific embodiments pictured and described herein, but are intended to apply to all similar apparatuses for providing any of the advantages of a hybrid bearing 10, 10′. Modifications and alterations from the described embodiments will occur to those skilled in the art without departure from the spirit and scope of hybrid bearing 10, 10′.

1. A hybrid bearing comprising:
a. a stator comprising:
i. a gas sector fluidly connected to a compressed fluid source, wherein said gas sector comprises a bearing pad with an active surface, and wherein a compressed fluid from said compressed fluid source exits said bearing pad at said active surface;
ii. a magnetic sector connected to an electricity source, wherein said magnetic sector comprises a coil, and wherein said electricity source provides an electrical current to said coil to form a magnetic field;
b. a rotor rotatable with respect to said stator, said rotor comprising:
i. a ferromagnetic portion, wherein said ferromagnetic portion is positioned adjacent said magnetic sector at least once during a full rotation of said rotor with respect to said stator.

2. The hybrid bearing according to claim 1 wherein said hybrid bearing is further defined as a radial hybrid bearing.

3. The hybrid bearing according to claim 2 wherein said magnetic sector is further defined as positioned on the upper 180 degrees of said stator relative to a radial plane of said stator.

4. The hybrid bearing according to claim 3 wherein said gas sector is further defined as positioned on the lower 180 degrees of said stator relative to said radial plane of said stator.

5. The hybrid bearing according to claim 4 wherein said rotor is further defined as being engaged with a shaft passing through said radial hybrid bearing.

6. The hybrid bearing according to claim 5 wherein said gas sector is further defined as supporting the weight experienced by said shaft.

7. The hybrid bearing according to claim 1 wherein said hybrid bearing is further defined as an axial hybrid bearing.

8. The hybrid bearing according to claim 7 wherein said hybrid bearing further comprises a plurality of magnetic sectors and a plurality of gas sectors having a plurality of bearing pads, wherein said plurality of magnetic sectors and said plurality of gas sectors are positioned on said stator.

9. The hybrid bearing according to claim 8 wherein said plurality of bearing pads further comprises a channel formed therein to accommodate said coil.

10. The hybrid bearing according to claim 1 wherein said bearing pad is further defined as being biased toward said rotor.

11. The hybrid bearing according to claim 1 wherein a clearance between said gas sector and said rotor is less than a clearance between said magnetic sector and said rotor during operation.

12. The hybrid bearing according to claim 1 wherein said electricity source is further defined as a magnetic bearing controller, wherein said magnetic bearing controller is engaged with an external electricity source, and wherein said magnetic bearing controller varies said magnetic field according to a predetermined set of desired operating conditions.

13. The hybrid bearing according to claim 1 wherein said rotor and said ferromagnetic portion are co-extensive, and wherein said ferromagnetic portion is further defined as positioned adjacent said magnetic sector continuously during operation of said hybrid bearing.

14. A radial hybrid bearing comprising:
a. a stator comprising:
i. a gas sector fluidly connected to a compressed fluid source, wherein said gas sector comprises a bearing pad with an active surface, wherein a compressed fluid from said compressed fluid source exits said bearing pad at said active surface, and wherein said gas sector is positioned on the lower 180 degrees of said stator relative to a radial plane of said stator;
ii. a magnetic sector connected to an electricity source, wherein said magnetic sector comprises a coil, wherein said electricity source provides an electrical current to said coil to form a magnetic field, and wherein said magnetic sector is positioned on the upper 180 degrees of said stator relative to said radial plane of said stator;
b. a rotor rotatable with respect to said stator, said rotor comprising:
i. a ferromagnetic portion, wherein said ferromagnetic portion is positioned adjacent said magnetic sector at least once during a full rotation of said rotor with respect to said stator.

15. The radial hybrid bearing according to claim 14 wherein said gas sector further comprises a plurality of bearing pads, and wherein said compressed fluid enters each said bearing pad via a sealed surface of said bearing pad.

16. The radial hybrid bearing according to claim 14 wherein said bearing pad is further defined as being biased toward said rotor via a biasing member.

17. The radial hybrid bearing according to claim 16 wherein said biasing member is further defined as a Belleville washer.

18. The radial hybrid bearing according to claim 14 wherein a post provides said compressed fluid to said bearing pad.

19. A method comprising:
a. engaging a rotor with a rotatable shaft;
b. positioning a stator adjacent said rotor, wherein said stator comprises:
i. a gas sector fluidly connected to a compressed fluid source, wherein said gas sector comprises a bearing pad with an active surface, and wherein a compressed fluid from said compressed fluid source exits said bearing pad at said active surface;
ii. a magnetic sector connected to an electricity source, wherein said magnetic sector comprises a coil, and wherein said electricity source provides an electrical current to said coil to form a magnetic field;
c. employing a hybrid bearing by using said gas sector to react a steady-state load imparted to said hybrid bearing via shaft; and
d. using said magnetic sector and a control system therefor to react a dynamic load imparted to said hybrid bearing via said shaft.

20. The method according to claim 19 further comprising the step of stabilizing said hybrid bearing via said magnetic sector and said control system therefor.
